(19) United States
(12) Patent Application Publication
(10) Pub. No.: US 2011/0235195 A1
(43) Pub. Date: Sep. 29, 2011

(54) VOICE COIL MOTOR AND CAMERA MODULE USING SAME

(75) Inventor: CHAU-YUAN KE, Tu-Cheng (TW)

(73) Assignee: HON HAI PRECISION INDUSTRY CO., LTD., Tu-Cheng (TW)

(21) Appl. No.: 12/797,494

(22) Filed: Jun. 9, 2010

(30) Foreign Application Priority Data
Mar. 25, 2010 (TW) 99108932

(51) Int. Cl. G02B 7/04

(52) U.S. Cl. 359/824

(57) ABSTRACT

A voice coil motor includes an outer shell, magnetic members, a base, first and second elastic members, and a movable assembly. The outer shell has a top wall and sidewalls. The magnetic members are mounted on the inside of the sidewalls. The first elastic member is sandwiched between the top wall and the magnetic members, and has a ring-shaped first elastic portion. The second elastic member is fixed on the base, and has a ring-shaped second elastic portion. The movable assembly comprises a ring-shaped retainer wrapped in a coil of wire. The retainer is connected to the first elastic portion and the second elastic portion. The magnetic members and the coil of wire are configured for cooperating to drive the movable assembly to move in the outer shell. A camera module using the voice coil motor is also provided.

### CROSS-REFERENCE TO RELATED APPLICATION

This application is related to a commonly-assigned co-pending application entitled “VOICE COIL MOTOR AND CAMERA MODULE WITH SAME” (Atty. Docket No. US32307). The disclosure of the above-identified application is incorporated herein by reference.

### BACKGROUND

1. Technical Field

The present disclosure relates to motors, and particularly to a voice coil motor and a camera module using same.

2. Description of Related Art

Voice coil motors (VCMs) are widely used, for example, as lens actuators in camera modules. Camera modules are becoming progressively more miniaturized over time, and thus VCMs are correspondingly being required to be made smaller and smaller.

A typical VCM includes an outer shell housing one or more magnets fixed to a frame, a lens retainer wrapped by a coil of wire, one or two elastic members connected between the lens retainer and the frame. The lens retainer is movable in the outer shell due to an interaction between the coil of wire and the magnetic members.

However, with the above configuration, too many elements are needed for the VCM. In addition, when the VCM is used in a camera module, a base is also needed for accommodating an image sensor, thus the entire camera module is not compact.

What is needed, therefore, is a voice coil motor and a camera module, which can overcome the above shortcomings.

### BRIEF DESCRIPTION OF THE DRAWINGS

Many aspects of the present voice coil motor and camera module can be better understood with reference to the following drawings. The components in the drawings are not necessarily drawn to scale, the emphasis instead being placed upon clearly illustrating the principles of the present voice coil motor and camera module. Moreover, in the drawings, like reference numerals designate corresponding parts throughout the several views.

FIG. 1 is a schematic view of a voice coil motor in accordance with a first embodiment.

FIG. 2 is an exploded view of the voice coil motor of FIG. 1.

FIG. 3 is a cross-sectional view of the voice coil motor shown in FIG. 1, taken along line III-III.

FIG. 4 is an exploded view of a voice coil motor in accordance with a second embodiment.

FIG. 5 is a schematic view of a camera module in accordance with a third embodiment.

### DETAILED DESCRIPTION

Embodiments of the present voice coil motor and camera module will now be described in detail below and with reference to the drawings.

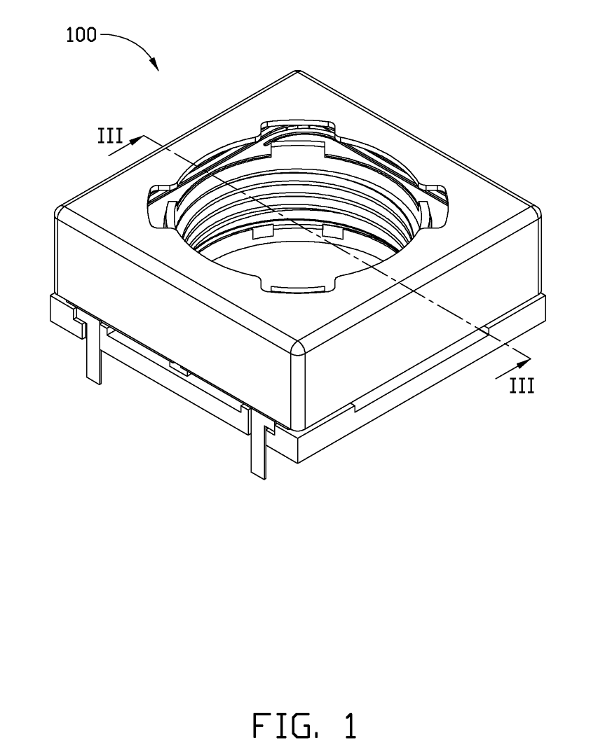

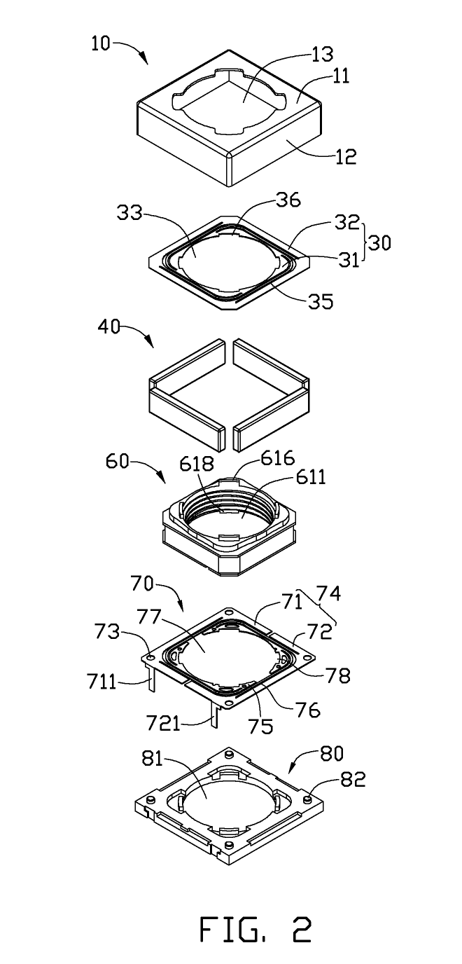

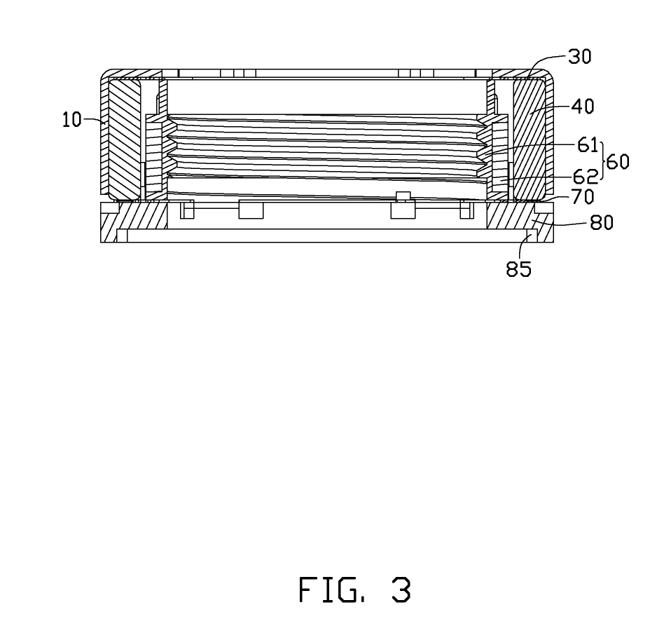

Referring to FIGS. 1 to 3, a voice coil motor 100 in accordance with a first embodiment is provided. The voice coil motor 100 mainly includes an outer shell 10, an upper elastic member (first elastic member) 30, four magnetic members 40, a movable assembly 60, a lower elastic member (second elastic member) 70 and a base 80.

The outer shell 10 includes a top wall 11 and four sidewalls 12. The top wall 11 has a light incident opening 13 formed in a center thereof. The top wall 11 and the sidewalls 12 cooperatively housing the other elements of the voice coil motor 100 except the base 80 and the lower elastic member 70. The outer shell 10 is made of electrically conductive materials, such as a conductive alloy, a conductive polymer, or conductive glass, whereby the outer shell 10 provides electro magnetic interference (EMI) shielding for the voice coil motor 100.

The upper elastic member 30 includes an elastic portion 31, a rigid portion 32 surrounding the elastic portion 31, and a plurality of substantially L-shaped slots 35 arranged between the rigid portion 32 and the elastic portion 31. The elastic portion 31 has a through hole 33 formed in a center thereof, and four recesses 36 formed in the inner wall of the elastic portion 31. The slots 35 contribute to the elasticity of the elastic portion 31.

The four magnetic members 40 are permanent magnets. The four magnets 40 are directly mounted on the inside of the four sidewalls 12 rather than on a fixing frame. The upper elastic member 30 is located between the top wall 11 and the four magnets 40, with the rigid portion 32 sandwiched between the top wall 11 and the magnets 40. With this configuration, the elastic portion 31 has space below the rigid portion 32 for movement.

In other embodiments, a ring-shaped spacer (not shown) can be sandwiched between the top wall 11 and the rigid portion 32 of the upper elastic member 30, whereby the elastic portion 31 can have space for movement above and below the rigid portion 32.

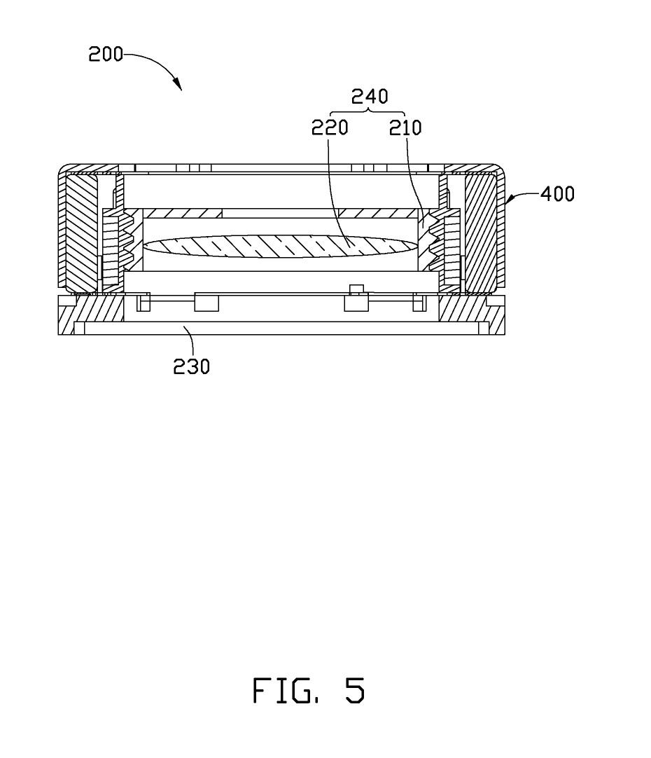

The movable assembly 60 includes a ring-shaped retainer 61 wrapped in a coil of wire 62. The retainer 61 has four top protrusions 616 and four bottom protrusions 618 extending thereon. The retainer 61 has a receiving space 611 defined therein. The outer wall of the retainer 61 is substantially rectangular-shaped, whereas the inner wall of the retainer 61 is circular. An inner thread is formed on the inner wall of the retainer 61, and configured for threadedly retaining a lens module (see FIG. 5) therein.

The lower elastic member 70 includes an elastic portion 75, a rigid portion 74 and a plurality of L-shaped slots 76 arranged between the elastic portion 75 and the rigid portion 74. The elastic portion 75 has a through hole 77 formed in a center thereof. The rigid portion includes a first part 71 and a second part 72 spaced from the first part 71. The first part 71 has a first lead 711 extending therefrom, and the second part 72 has a second lead 721 extending therefrom. The first part 71 and the second part 72 are electrically connected to the two ends of the coil of wire 62, and the first lead 711 and the second lead 721 are electrically connected to an outside power supply. In this way, the coil of wire 62 can be charged.

The first part 71 and the second part 72 each further have two engaging holes 73 formed therein. The elastic portion 75 further has four recesses 78 formed in the inner wall thereof.

The base 80 is also ring-shaped, and has a through hole 81 formed in a center thereof and accommodating space 85 in communication with the through hole 81. The accommodating space 85 can accommodate an image sensor (see FIG. 5) therein. The base 80 further has four protrusions 82 thereon. The protrusions 82 are engaged in the engaging holes 73 of the lower elastic member 70, respectively, and a glue may be applied thereon to further fix the lower elastic member 70 to the base 80.

The protrusions 616 of the retainer 61 are engaged in the recesses 36 of the upper elastic member 30, and the protrusions 618 of the retainer 61 are engaged in the recesses 78 of the lower elastic member 70. A glue may be applied to the protrusions 616, 618 to fix the retainer 61 to the elastic portions 31 and 75.

In application, the movable assembly 60 is movable upwards and downwards in the outer shell 10 due to the interaction between the coil of wire 62 and the magnetic members 40.

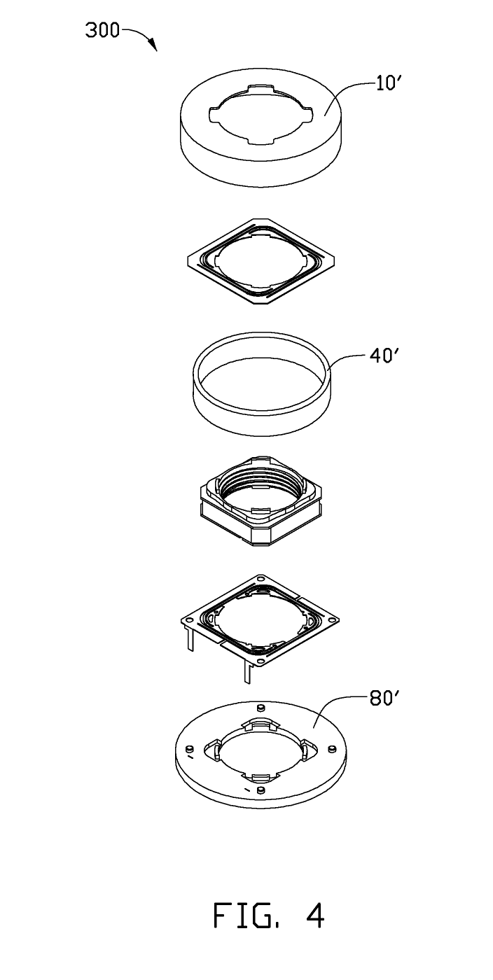

Referring to FIG. 4, a voice coil motor 300 in accordance with a second embodiment is provided. The voice coil motor 200 is essentially similar to the voice coil motor 100 illustrated above, except that an outer shell 10′ and a base 80′ each having a circular cross section are used, and only one magnetic member 40′, which has a circular cross section, is used.

Referring to FIG. 5, a camera module 200 in accordance with a third embodiment, is provided. The camera module 200 includes a voice coil motor 400, a lens module 240 and image sensor 230. The voice coil motor 400 can be the same as the voice coil motor 100 or the voice coil motor 200. The lens module 240 includes a lens barrel 210 and a lens 220 received in the lens barrel 210. The lens barrel 210 is externally threaded and engagable with the inner thread of the retainer of the voice coil motor 400. The image sensor 230 is accommodated in the accommodating space of the base of the voice coil motor 400, thus no separate base for the image sensor is needed. The entire camera module 200 is compact.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A voice coil motor, comprising:
an outer shell having a top wall and a plurality of sidewalls, the top wall having a through hole defined therein;
a plurality of magnetic members mounted on the inside of the sidewalls, respectively;
a first elastic member sandwiched between the top wall and the magnetic members, the first elastic member having a ring-shaped first elastic portion;
a base;
a second elastic member fixed on the base, the second elastic member having a ring-shaped second elastic portion; and
a movable assembly comprising a ring-shaped retainer and a coil of wire wrapped therearound, the retainer connected to the first elastic portion and the second elastic portion, the magnetic members and the coil of wire configured for cooperating to drive the movable assembly to move in the outer shell.

2. The voice coil motor of claim 1, wherein each of the first and second elastic portions comprises a plurality of recesses formed therein, the retainer comprises a plurality of top protrusions and bottom protrusions, the top and bottom protrusions engaged in the recesses, respectively.

3. The voice coil motor of claim 1, wherein the first elastic member further comprises a first rigid portion surrounding the first elastic portion, and a plurality of L-shaped slots arranged between the first elastic portion and the first rigid portion.

4. The voice coil motor of claim 1, wherein each of the magnetic members is a permanent magnet.

5. The voice coil motor of claim 1, wherein the second elastic member further comprises a second rigid portion surrounding the second elastic portion, and a plurality of L-shaped slots arranged between the second elastic portion and the second rigid portion; the second rigid portion comprises a first part and second part spaced from the first part; the coil of wire is electrically connected to the first and second parts.

6. The voice coil motor of claim 5, wherein the first part has a first lead, the second part has a second lead, the first and second leads are configured for electrically connecting to a power supply to electrify the coil of wire.

7. The voice coil motor of claim 5, wherein each of the first and second parts comprises a plurality of engaging holes formed therein, the base comprises a plurality of protrusions formed thereon, for engaging in the engaging holes, respectively.

8. The voice coil motor of claim 1, wherein the base comprises a through hole defined therein and an accommodating space in communication with the through hole.

9. The voice coil motor of claim 1, wherein the retainer has an inner thread formed therein.

10. The voice coil motor of claim 1, wherein the outer shell is made of electrically conductive material.

11. A voice coil motor, comprising:
an outer shell made of electrically conductive material, and having a top wall and a plurality of sidewalls, the top wall defining a through hole therein;
a ring-shaped magnetic member mounted on the inside of the sidewalls;
a first elastic member sandwiched between the top wall and the magnetic member, the first elastic member having a ring-shaped first elastic portion;
a base comprises a through hole defined therein and an accommodating space in communication with the through hole;
a second elastic member fixed on the base, the second elastic member having a ring-shaped second elastic portion; and
a movable assembly comprising a retainer and a coil of wire wrapped therearound, the retainer having a receiving space defined therein, the retainer connected to the first elastic portion and the second elastic portion, the magnetic members and the coil of wire configured for cooperating to drive the movable assembly to move in the outer shell.

12. The voice coil motor of claim 11, wherein the retainer has an inner thread formed therein.

13. The voice coil motor of claim 11, wherein each of the first and second elastic portions comprises a plurality of recesses formed therein, the retainer comprises a plurality of top protrusions and bottom protrusions, the top and bottom protrusions engaged in the recesses, respectively.

14. The voice coil motor of claim 11, wherein the first elastic member further comprises a first rigid portion surrounding the first elastic portion, and a plurality of L-shaped slots arranged between the first elastic portion and the first rigid portion.

15. The voice coil motor of claim 11, wherein the second elastic member further comprises a second rigid portion surrounding the second elastic portion, and a plurality of L-shaped slots arranged between the second elastic portion and the second rigid portion; the second rigid portion comprises a first part and second part spaced from the first part; the coil of wire is electrically connected to the first and second parts.

16. The voice coil motor of claim 15, wherein the first part has a first lead, the second part has a second lead, the first and second leads are configured for electrically connecting to a power supply to electrify the coil of wire.

17. The voice coil motor of claim 15, wherein each of the first and second parts comprises a plurality of engaging holes formed therein, the base comprises a plurality of protrusions formed thereon, for engaging in the engaging holes, respectively.

18. A camera module, comprising:
an outer shell having a top wall and a plurality of sidewalls, the top wall having a through hole defined therein;
at least one magnetic member mounted on the inside of the sidewalls;
a first elastic member sandwiched between the top wall and the at least one magnetic member, the first elastic member having a ring-shaped first elastic portion;
a base comprises a through hole defined therein and an accommodating space in communication with the through hole;
an image sensor accommodated in the accommodating space;
a second elastic member fixed on the base, the second elastic member having a ring-shaped second elastic portion;
a movable assembly comprising a retainer and a coil of wire wrapped therearound, the retainer having a receiving space defined therein, the retainer connected to the first elastic portion and the second elastic portion, and being movable in the outer shell under an interaction between the magnetic members and the coil of wire; and
a lens received in the receiving space of the retainer.

19. The camera module of claim 18, wherein further comprising a lens barrel receiving the lens therein and having an outer thread formed thereon, the retainer having an inner thread formed therein, the lens barrel being threadedly engaged with the retainer.
